(19) United States
(12) Patent Application Publication
(10) Pub. No.: US 2009/0313754 A1
(43) Pub. Date: Dec. 24, 2009

(54) Evacuation Sheet

(76) Inventors: Johannes Petrus Cornelis Maria Smoor, Riethoven (NL); Petrus Hubertus Gerardus Maria Hezemans, Eersel (NL)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/307,477

(22) PCT Filed: Jul. 3, 2004
(86) PCT No.: PCT/NL07/00167

§ 371 Date: Jul. 7, 2009

(30) Foreign Application Priority Data
Jul. 6, 2006 (NL) 1032127
Jan. 25, 2007 (NL) 1033283

(51) Int. Cl. A61G 7/10

(52) U.S. Cl. 5/81.1 R

(57) ABSTRACT

The present invention relates to a device for evacuating a person lying on a mattress, comprising a central portion having two opposite long sides and two opposite short sides, which sides substantially correspond to those of a mattress with which the device is used, said device comprising wrapping means for wrapping the mattress and a person lying thereon, said wrapping means comprising an at least partially flexible wrapping element having two projecting parts which each extend from underneath a respective long side of the mattress in the wrapping position, and fastening means for fastening the two projecting parts together when forming the envelope, wherein said at least one flexible wrapping element of the device according to the invention comprises a first wrapping sheet on a first long side of the central portion. The invention further relates to a method for evacuating a person lying on a mattress by means of such a device.

The present invention relates to a device for evacuating a person lying on a mattress, comprising a central portion having two opposite long sides and two opposite short sides, which sides substantially correspond to those of a mattress with which the device is used, said device comprising wrapping means for wrapping the mattress and a person lying thereon, said wrapping means comprising an at least partially flexible wrapping element having two projecting parts which each extend from underneath a respective long side of the mattress in the wrapping position, and fastening means for fastening the two projecting parts together when forming the envelope.

Such a device is known from British patent application GB-A-2030047.

In the event of a calamity, such as a fire in a building in which bedridden persons are nursed, it is important that these persons can be evacuated from the building in question as rapidly as possible. Since the persons in question are confined to their beds, this constitutes a problem, the more so because lifts may not be used under those circumstances. The aforesaid British patent application describes how use can be made of a sheet that is laid directly under the mattress in spread-out condition. Two transverse straps are attached to the sheet some distance apart, which straps are provided with buckle elements at their ends to enable the ends of respective straps to be fastened together. The strap has a certain excess length on a long side of the sheet, which can be passed over a mattress and a person lying on the mattress to the opposite long side of the mattress, where the buckle elements of the strap in question can be fastened together and subsequently the strap in question can be tensioned. Normally, however, the excess length of the strap is folded under the mattress, being held in place there by means of elastic loops. The excess length can be pulled from under the mattress by giving a tug at the buckle element that is connected to the excess length portion of the strap and which is located under a side of a mattress in the inoperative condition of the evacuation sheet, thereby breaking the connections of elastic loops. When a person lying on a mattress has been strapped down on the mattress, the mattress with the person lying thereon can be pulled from the bed, to which end a loop projecting under the mattress is provided at the head end and the foot end of the sheet.

An important disadvantage of the evacuation device as described in GB-A-2030047 is that the buckle elements and the associated straps are separate elements, which must be separately packed and fitted, which is time-consuming and which is very difficult when a patient is agitated. Pulling the excess length of the respective straps from under the mattress must be done from a long side of the mattress, whilst subsequently the buckle elements must be fastened together on the other long side of the mattress, which takes up a considerable amount of time. This is very disadvantageous in the event of a calamity, of course, since the operations in question take up valuable time. Moreover, it has become apparent in practice that the buckle elements often become hidden under the mattress, for example as a result of the bed being made up frequently. Staff consider the presence of the buckles to be objectionable. Furthermore, the possibilities of grasping such a buckle element are not optimal. Further the straps can cut into the body of the bed-ridden person during evacuation, which can cause wounds. The risk of cutting is even higher for women, because the straps that are applied around the chest can cut into the women's breasts.

The object of the present invention is to provide a device according to the introductory paragraph which makes it possible to wrap and protect a person on a mattress and thus prepare said person for evacuation within a very short period of time. In order to accomplish that object, said at least one flexible wrapping element of the device according to the invention comprises a first wrapping sheet on a first long side of the central portion. The wrapping sheet replaces the straps of the known device, which is advantageous in that the mattress and the person lying thereon can be entirely or at least largely enveloped in one motion by passing the wrapping sheet over the mattress. This saves time in comparison with the prior art device, in which a number of straps must be separately passed over the mattress. Moreover, the wrapping sheet provides better protection than the straps with the buckle elements of the prior art device. In the first place because a person is better protected against falling from the mattress when a wrapping sheet is used, because the person who is constricted cannot slide or slip between straps. In the second place, a material which is better able to withstand fire, for example, than the blankets or sheets that usually cover a person on a mattress can be selected as the material for the protective sheet. Additionally the risk of cutting wounds caused by the straps is considerably decreased, because with a sheet the pressure is distributed to the body over a larger surface than with the known straps.

U.S. Pat. No. 5,249,321 discloses a device for evacuating a bed-ridden person lying on a matrass. The device has a central part with two opposite long sides and two opposite short sides, the dimensions of which are considerably smaller than that of the matrass. Further a separate sheet is provided which can be positioned at and attached to the central part. Covers in the form of sheets are attached to the short sides of the central part by means of cords. One of these sheets is provided with an opening through which, in use, the head of a person lying on the matrass can be put. The sheets are provided with Velcro for mutually connecting the overlapping sheets and with cords and loops for connecting the sheets with the central part which in use underlies the matrass. In a situation of evacuation the upper sheet has to be carefully positioned over the head of the bed-ridden person and additionally cords have to be tightened to securely envelop the person and the matrass. The device is thus a complex assembly and handling of all parts without disarrangement thereof slows down a possible evacuation procedure, in which each second can be of vital importance.

U.S. Pat. No. 5,150,487 A discloses an evacuation device with an essentially rectangular base sheet with a relatively stiff support element which can be disposed under a matrass. Straps and loops are provided at opposite long sides of the base sheet. In case of an evacuation the straps that are provided at one long side must be removed from under the matrass to bring these straps to the loops which are provided at the opposite long side of the base sheet. By pulling the straps the matrass is tightened so that, as it were, the patient is rolled in the matrass. Such a procedure is not only time consuming because the straps and loops of opposite sides of the matrass have to be brought together, than must be attached to each other and then must be tightened, but this also requires much force to be applied by a person to carry out the procedure, because the matrass must be wrapped around the person by pulling the straps. This is especially heavy because matrasses for bed-ridden persons, for which such an evacuation device is intended, are normally designed as a heavy embodiment to provide a good support of a patient.

U.S. Pat. No. 6,568,015 B1 discloses a matrass for comfortably supporting an individual with an abdominal condition requiring minimal contact between the matrass and the individuals abdomen. Sheets can be wrapped around the body of the individual before the matrass is rotated about the longitudinal axis thereof with the individual secured thereto.

An important advantage of the evacuation device according to the present invention with respect to the state of art devices is that the evacuation of a person can be carried out easily and quickly, without unnecessarily spending time for tightening straps, cords or the like.

Preferably, the at least partially flexible wrapping element comprises a second wrapping sheet on the long side of the central portion that is located opposite said first long side of the central portion. This makes it possible to arrange the two wrapping sheets one over the other, as it were, thereby enabling an even better protection of the mattress and the person lying thereon. In addition, fastening means may be provided on the first and the second wrapping sheet, in such a manner that it is then easy to fasten the two wrapping sheets together for a rapid evacuation.

In order to cover the mattress and the person lying thereon on three sides, the wrapping means preferably comprise a third wrapping sheet on a short side of the central portion. When such an arrangement is used, an opening that is left clear at the foot end of the mattress by the first and possibly the second wrapping sheet is closed, so that the mattress and/or the person cannot slip from the confines of the wrapping material at the foot end. In the event of an evacuation this makes it possible to move the mattress and the person lying thereon along an inclined or vertical plane with the foot end downwards without the risk of the person slipping from the confines of the wrapping material, with or without the mattress, at the foot end.

To provide an adequate protection against open fire during an evacuation, the first, the second and/or the third wrapping sheet preferably comprise(s) a fire retardant material. Fire is a frequent reason for evacuation, and the bedclothes covering a person on a mattress might easily catch fire in the event of an evacuation near open fire and/or sparks. The fire retardant material helps to prevent the bedclothes or a mattress from catching fire during an evacuation.

In a preferred embodiment of the present invention, the device comprises at least one self-inflatable gas chamber, which is connected to said at least one wrapping sheet for moving the at least one wrapping sheet from under the mattress on at least one long side of the mattress upon inflation of the gas chamber, and control means for triggering the self-inflation of the gas chamber. The use of said at least one self-inflatable gas chamber makes it possible to make the at least one wrapping sheet that is needed for at least partially wrapping a person available for this purpose extremely quickly with a minimum physical effort merely by suitably activating the control means at a suitable point in time, so that the gas chamber will inflate itself.

Preferably, the device comprises two self-inflatable gas chambers connected to the respective wrapping sheets for moving the wrapping sheets from under the mattress on the respective long sides of the mattress upon inflation of the gas chambers. Thus the wrapping sheets are made available on both long sides of the mattress for wrapping the mattress and the person lying thereon. To make it possible to have all the activities required for wrapping a mattress, including the person lying thereon, from a long side, which is advantageous in particular if the bed with the mattress present thereon is positioned against or at least near a wall of a room, it is preferable if the gas chamber independently extends at least partially upwards along the respective long side of the mattress in the inflated condition.

This advantage is even more relevant if according to another preferred embodiment the gas chamber independently takes on a curved shape in inflated condition so as to envelope the person to be evacuated at least partially. The larger the dimensions of the gas chamber in a direction transversely to the longitudinal direction of the mattress, the greater the protection the gas chamber will be able to confer to the patient on the mattress during the eventual evacuation if the gas chamber itself envelopes the person at least partially.

The self-inflation of the gas chamber can take place very rapidly if said at least one gas chamber comprises a gas cartridge. The use of such gas cartridges, for example CO₂ cartridges, is already known per se from life jackets. As the volume of the gas chamber increases, it may be desirable to use a number of gas cartridges instead of one gas cartridge for each gas chamber, which gas cartridges are preferably activated by the same control means. Furthermore it is possible to place several gas chambers, for example located on different long sides, in communication with each other, for example by means of a hose or the like, so that the gas chambers in question will be inflated simultaneously.

A very efficient use of material is obtained if at least part of the wall of the gas chamber forms part of the associated projecting part.

The control means preferably comprise a pull cord in a striking alarm colour, a free end of which projects slightly below the mattress.

The fastening means preferably comprise Velcro. A correct orientation of the Velcro enables rapid fastening. In the embodiment comprising two or three wrapping sheets, for example, one or two wrapping sheets may be provided with Velcro on the upper side, which is to engage with Velcro provided on the bottom side of one or two other wrapping sheets, which are to be arranged over the wrapping sheet(s) provided with Velcro on the upper side. Since a wrapping sheet is according to the present invention attached to one side of the central portion of the device, the orientation of such a wrapping sheet is mainly defined in the folded condition thereof. A correct orientation, for example an orientation in which mating Velcro sides in the form of strips extending perpendicularly to each other are provided, makes it possible to ensure that there will be sufficient contact between the mating Velcro sides at all times after wrapping of the mattress and the person lying thereon has taken place. Since the two or more wrapping sheet are automatically fastened together upon being arranged one over the other, this contributes to a rapid evacuation.

It is preferable in that regard if the device is provided with positioning means for positioning at least a part of the wrapping means under a mattress. As such the positioning means make it easier to locate the wrapping sheet in question especially in the evacuation sheet without gas chambers. The advantage of said positioning of at least a part of the wrapping sheets is that the wrapping sheets will remain hidden from view as long as no evacuation is taking place. The fact that the wrapping sheets remain hidden from view also has advantages for the staff who attend to a person who is lying on the mattress. The wrapping sheets may have been or be positioned in such a manner that they hardly interfere, if at all, with the bedmaking. It is also possible to position the wrapping sheets in such a manner that an attendant who must pass a wrapping sheet over the mattress will know in advance where to find the wrapping sheet in question under a mattress. In the case of straps this is hardly possible, for example, because straps, much more so than sheets, are apt to be displaced, for example during bedmaking.

To provide easy access and make it possible to pull a wrapping sheet from under the mattress with a relatively small effort, it is preferable if the positioning means are suitable for maintaining the wrapping sheet in question in a desired position under a mattress.

The positioning means preferably comprise Velcro. Not only does Velcro provide a simple and strong connection, but if Velcro having a suitable, comparatively low pull strength is used, it is also possible to break the Velcro connection with a relatively small effort. It is possible to use a type of Velcro that provides a less strong connection for the positioning means than for fastening the wrapping sheets together, so that said Velcro connection can be pulled loose comparatively easily.

The positioning means are preferably at least in part provided on one or more wrapping sheets. This makes it possible to realise a comparatively simple embodiment of a device according to the present invention.

To enable easy handling of a wrapping sheet in the event of an evacuation, it is preferable if the first, the second and/or the third wrapping sheet is (are) provided with at least one handle. A handle makes it possible to take a firm hold of a wrapping sheet. Especially in the situation in which a wrapping sheet without a gas chamber is stored under a mattress prior to evacuation, the wrapping sheet can be pulled from under the mattress comparatively easily by means of the handle. Any opposing forces, such as a Velcro connection of the positioning means, can be overcome in a relatively simple manner as well with such a firm grasp.

In a preferred embodiment of the present invention, the device is provided with a dragging element on at least one short side. This enables easy handling by an attendant of a mattress wrapped in such a device in the event of an evacuation. Thus one, or possibly two attendant(s) can pull a mattress with a person lying thereon from the frame of a bed and subsequently drag it across a floor in the event of an emergency. If a device is provided with a third wrapping sheet, one person can be evacuated via a staircase, being protected by the mattress and the wrapping sheets, with an attendant possibly holding the device by the dragging element so as to slow it down.

The present invention further relates to a method for evacuating a person lying on a mattress, wherein the mattress, including a person lying thereon, is wrapped by means of a device according to the present invention. The advantages of such a method correspond to the advantages of the device in question.

The invention will now be explained in more detail by means of a description of a preferred embodiment of the present invention, in which reference is made to the following figures:

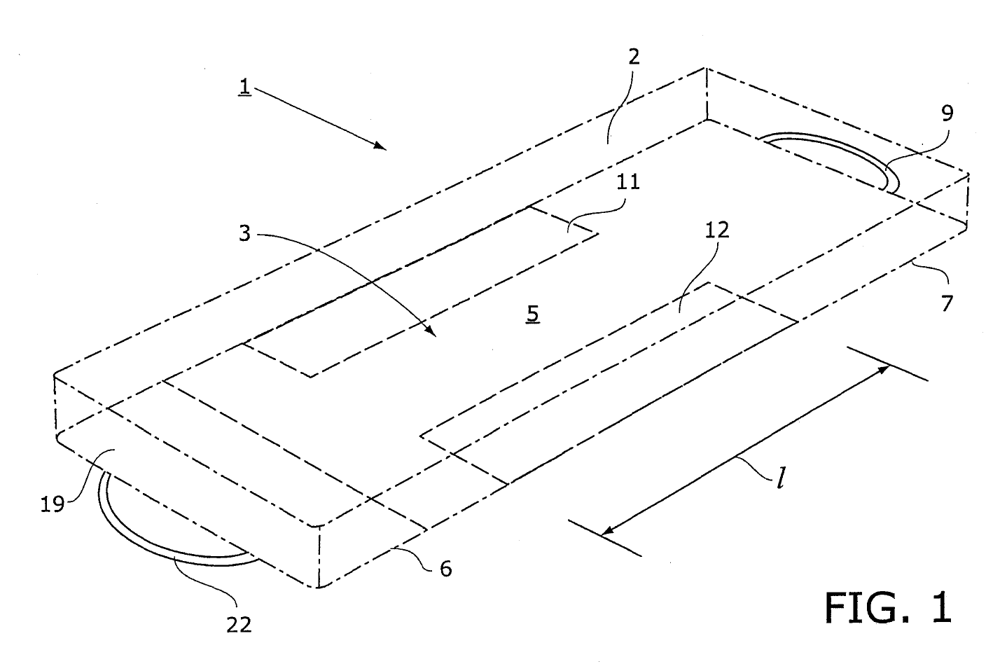

FIG. 1 is a perspective view of a device according to the invention in an inoperative condition, in combination with a mattress;

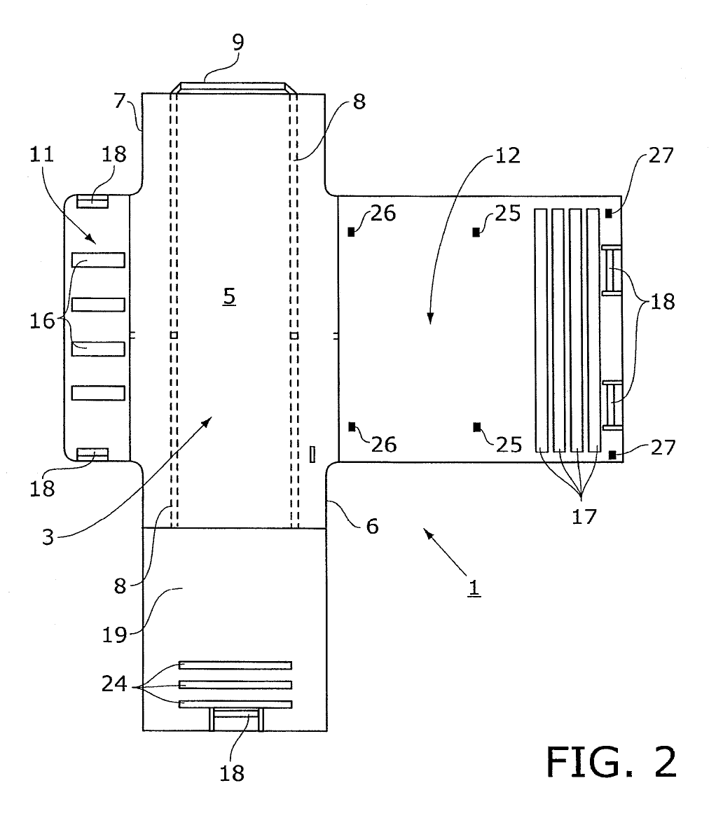

FIG. 2 is a schematic top plan view of the preferred embodiment of FIG. 1 in unfolded condition;

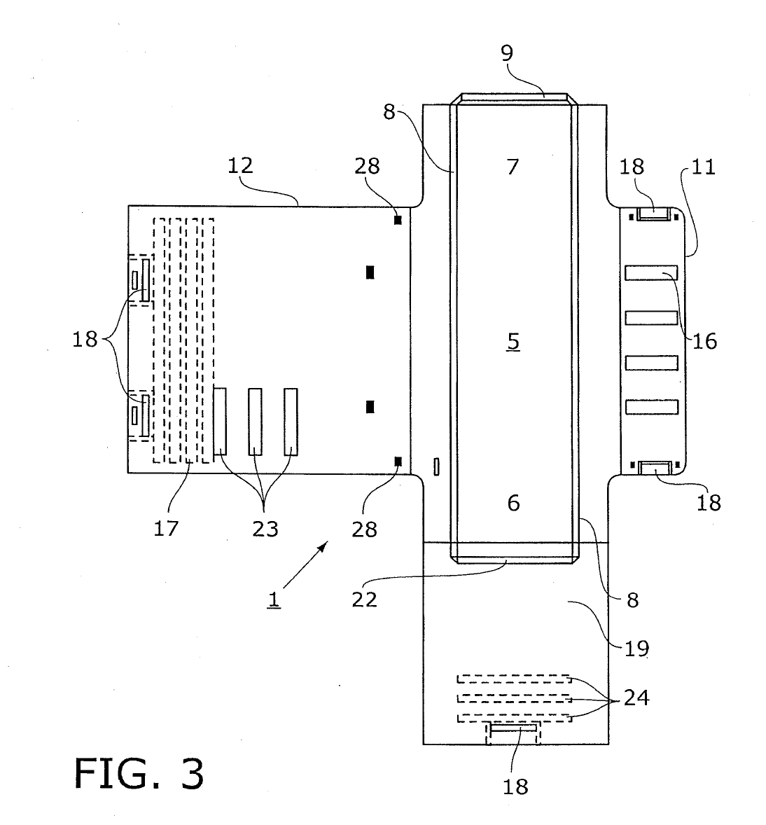

FIG. 3 is a schematic bottom plan view of the preferred embodiment of FIG. 1 in unfolded condition;

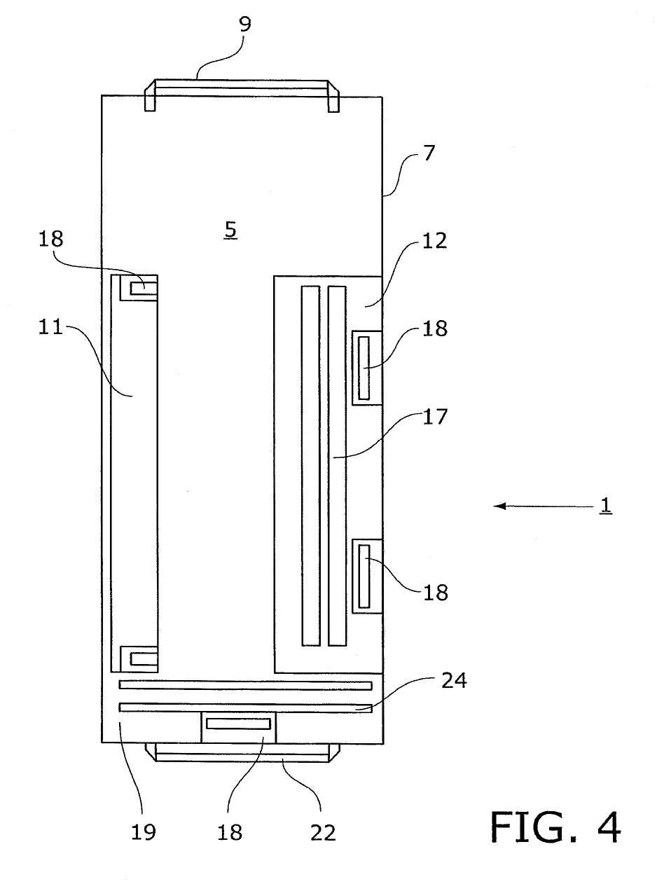

FIG. 4 is a schematic top plan view of the preferred embodiment of FIG. 1 in an inoperative condition;

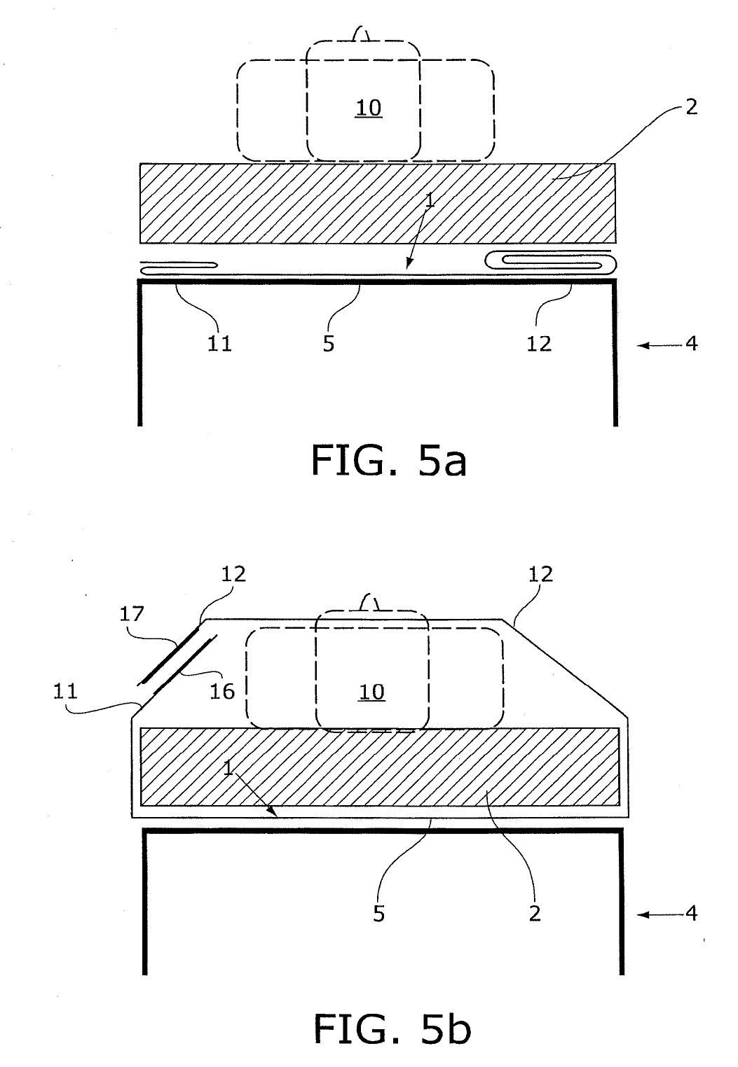

FIG. 5a is a schematic, vertical cross-sectional view of the preferred embodiment of FIG. 1 in an inoperative condition;

FIG. 5b is a schematic, vertical cross-sectional view of the preferred embodiment of FIG. 1 in use;

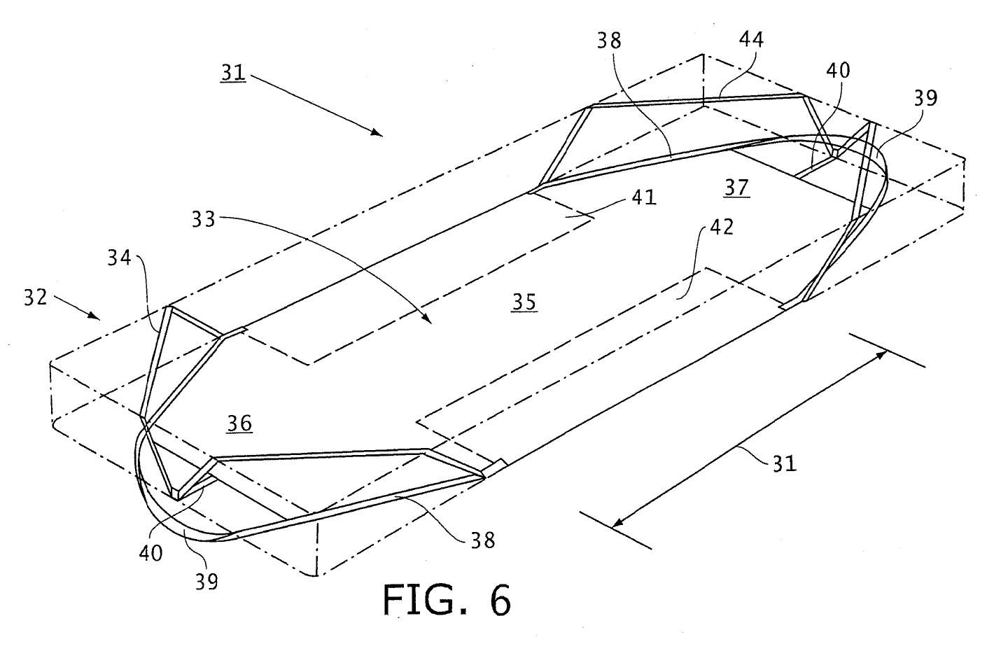

FIG. 6 is a perspective view of a second preferred embodiment of the device according to the invention in an inoperative condition;

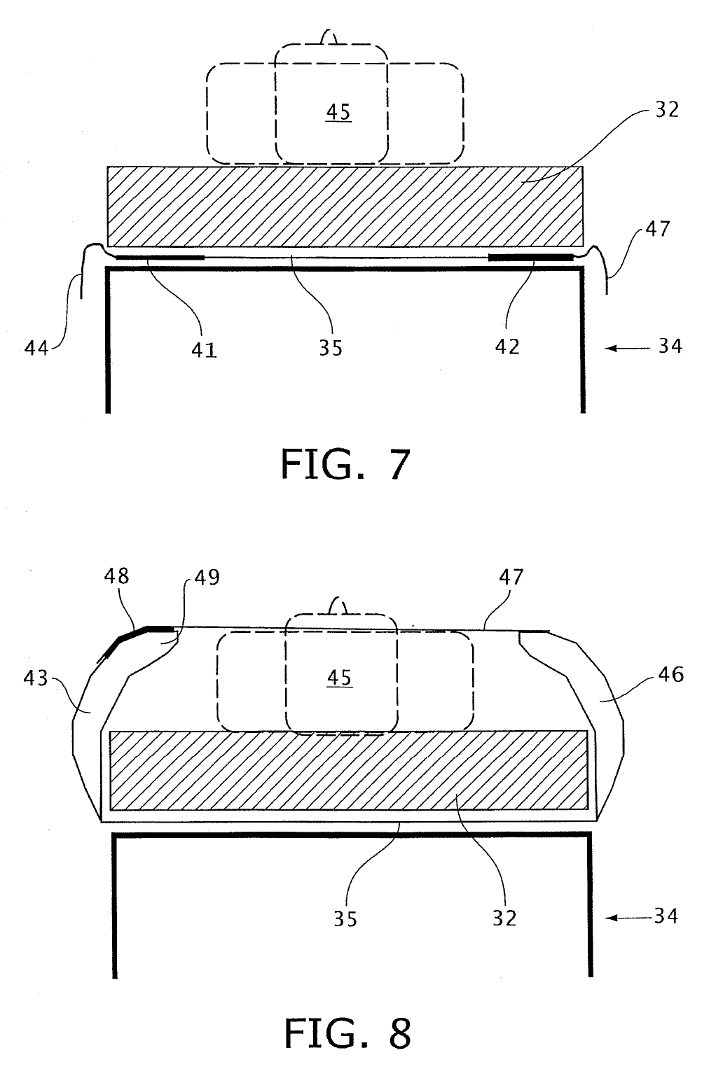

FIG. 7 is a schematic, vertical cross-sectional view of the preferred embodiment of FIG. 6 in an inoperative condition; and

FIG. 8 is a schematic, vertical cross-sectional view of the preferred embodiment of FIG. 6 in use.

FIGS. 1, 5a and 5b show a first preferred embodiment of the present invention in combination with a mattress. In FIGS. 2, 3 and 4 the preferred embodiment of FIG. 1 is shown, merely by way of illustration, separately in unfolded condition and in folded condition, i.e. in an inoperative condition. Like elements are consistently indicated by the same numerals in the figures.

FIGS. 6, 7 and 8 show a preferred embodiment of an evacuation device according to the present invention, which is provided with gas chambers that can be inflated, as a result of which the wrapping sheets can be moved from under a mattress.

FIG. 1 shows a mattress 2 with an evacuation device 1 according to the present invention consisting of a coated sheet 3 having a central portion 5 and end face portions 6, 7 and wrapping portions 11, 12, 19 present thereunder. The evacuation device 1 is provided with drag loops 22.

FIG. 2 is a schematic top plan view of the evacuation device 1 of FIG. 1, in this case in the unfolded condition thereof. The central portion 5 comprises reinforcing bands 8 and wrapping portions 11, 12, 19 provided with handles 18. Furthermore, pieces of Velcro 25, 27 are provided, which are to mate with respective pieces of Velcro 26 and 28 (see FIG. 3) for maintaining the evacuation device in the positioned, folded state (see FIG. 5a) in the inoperative condition thereof.

FIG. 3 is a schematic bottom plan view of the evacuation device 1 of FIG. 2. In addition to the above-discussed elements, Velcro material 16 and 23 is present on the wrapping portions 11 and 12, respectively, in FIG. 3, which Velcro material is to mate with Velcro material 17 and 24, respectively, on the upper side of the evacuation device 1, which is illustrated in dotted lines in FIG. 3. The Velcro material 28 is to mate with the Velcro material 27 of FIG. 2.

FIG. 4 is a schematic top plan view of the evacuation device 1 of FIG. 1 in the inoperative condition thereof, showing the evacuation device 1 in more detail in this case, with Velcro material 17, 24 and handles 18.

FIGS. 5a and 5b are cross-sectional views of an evacuation device of the former figures in the inoperative condition and in use, respectively. In FIG. 5a the evacuation device 1 is located between the bed 4 and the mattress 2 in its entirety, with the wrapping portions 11, 12 folded under the mattress 2 on the respective sides of the mattress 2. In FIG. 5b the wrapping portions 11, 12 are passed over the mattress 2 and the person 10, being fastened together by Velcro 16, 17.

In FIGS. 6, 7 and 8, like elements are indicated by a numeral which is 30 higher than the numeral used to indicate the corresponding element in FIGS. 1-5. Furthermore, gas chambers 43, 46 are provided.

FIG. 1 shows an evacuation device 1 according to a first preferred embodiment of the present invention in combination with a mattress 2, whose contours are illustrated in a chain-dotted line. The evacuation device 1 comprises a sheet 3, which, in the inoperative condition of the evacuation device 1 as shown in FIG. 1, is provided under the mattress 2 and above the bed 4 (see also FIGS. 5a on 5b). The sheet 3 is made of a fire-retardant, coated material, which is reinforced in several places in view of the loads that will act on the sheet during a possible evacuation. The sheet 3 comprises a central, rectangular portion 5 which extends substantially across the entire width of the mattress 2 (usually 80 or 90 cm) and which has a length l of about 120 cm in the longitudinal direction of the mattress 2. Seen in the direction of the short sides of the mattress, the sheet blends into end face portions 6, 7 from the central portion 5. Said end face portions 6, 7 may be rectangular or conical in shape, for example; in the present disclosure they are referred to a as end face portions for the sake of clarity of the explanation. A reinforcing band 8 is provided on both long sides of the central rectangular portion 5, which reinforcing band ends in a drag loop 9, 22 on the outer side of the end face portions 6, 7. Velcro material is provided in the centre of the drag loops 9, 22, making it possible to maintain the drag loops 9, 22 in the desired position, so that on the one hand said drag loops 9, 22 will not objectionably hang from the sides of the mattress 2, whilst on the other hand said drag loops 9, 22 will be accessible at all times for being grasped.

On the long side of the mattress 2, the sheet 3 furthermore comprises two wrapping portions 11, 12 (see also FIG. 2). Said wrapping portions 11, 12 are illustrated in dotted lines in FIG. 1. In the inoperative condition, the wrapping portions 11, 12 are folded onto the central portion 5 from the longitudinal edges of said central portion 5.

The wrapping portions 11, 12 are made of a coated fabric, which at least substantially extends along the length l. On one long side the coated fabric of the wrapping portion 12 is provided with a Velcro loop side 17 and on the other long side the coated fabric of the wrapping portion 11 is provided with a Velcro hook side 16. The Velcro material 16, 17 preferably extends at least over a significant part of the length l, so that a firm connection can be effected between the wrapping portion 12 and the wrapping portion 11. Thus a person 10, or at least said person's trunk, can be enveloped in the mattress 2, the wrapping portion 12 and the wrapping portion 11, with the bottom sides of the wrapping portions 11 and 12 being connected via the central portion 5 of the sheet 3. The wrapping portion 12 is preferably provided with handles 18, for example cut-out, edged handles, at the location of the Velcro material 17 to facilitate fastening the Velcro material 17 to the Velcro material 16.

In the event of an emergency, when it is necessary to evacuate a person 10 lying on a mattress 2, attendant staff will be able to remove the wrapping portions 11, 12 from under the mattress 2 very quickly by means of the handles 18. Standing beside the bed on the long side thereof, the attendant will grasp the wrapping portion 12, move round the bed to the long side of the wrapping portion 11 and then press the Velcro material 17 of the wrapping portion 12 onto the Velcro material 16 of the wrapping portion 12. The attendant will then pull the wrapping portion 19 for the feet from under the mattress 2 by means of the handle 18 thereof, pass it over the mattress and then fasten it by means of Velcro 23, 24. In this way the person 10 is completely enveloped and the actual evacuation can begin by dragging the evacuation device 1 together with the mattress 2 and the person 10 off the bed 4 by means of one or both drag loops 9, 22 and then to an (emergency) exit of the building in question. Thus, not only the mattress 2 but also the wrapping portions 11, 12 confer a certain degree of protection to the person 10 during the evacuation.

A major advantage of the evacuation device 1 is the minimum amount of time required for preparing the evacuation of the person 10.

FIG. 6 shows an evacuation device 31 according to a preferred embodiment of the present invention in combination with a mattress 32 whose contours are illustrated in a chain-dotted line. The evacuation device 31 comprises a sheet which, in the inoperative condition of the evacuation device 31 as shown in FIG. 6, is provided under the mattress 32 and above the bed 34 (see also FIGS. 7 and 8). The sheet 33 is made of a fire-retardant, coated material that is reinforced in several places in connection with the loads that will act on the sheet during a possible evacuation. The sheet 33 comprises a central, rectangular portion 35 which extends substantially across the entire width of the mattress 32 (usually 80 or 90 cm) and which has a length l of about 120 cm in the longitudinal direction of the mattress 2. Seen in the direction of the short sides of the mattress from the central portion 5, the sheet 33 blends into conical portions 36, 37 from the central portion 35. A reinforcing band 38 is provided at the longitudinal edges of the conical portions 36, 37, which ends in a drag loop 39 at the outer side of the conical portions 36, 37. A loop 40 extends from the centre of the short sides of the conical portions to the centre of he short sides of the mattress 32. Bands of elastic 34, which are stretched round the four corners of the mattress 32, extend through said loops 40. Said bands of elastic 34 retain the sheet 33 in the correct position under the mattress 32. Velcro is provided at the ends of the loops 40 as well as in the centre of the drag loops 39, making it possible to fasten the drag loops 39 to the loops 40, so that on the one hand said drag loops 39 will not objectionably hang from the sides of the mattress 32, whilst on the other hand said drag loops 9, 22 are accessible at all times for being grasped.

On the long sides of the mattress 32, the sheet 33 further comprises two wrapping portions 41, 42 (see also FIG. 2). Said wrapping portions 41, 42 are illustrated in dotted lines in FIG. 6. In the inoperative condition, the wrapping portions 41, 42 are folded under the central portion 35 from the longitudinal edges of said central portion 35.

The wrapping portion 41 comprises a gas chamber 43, which is shown in inflated condition in FIG. 8. The gas chamber 41 is provided with a CO₂ cartridge, which is disposed inside the gas chamber. The gas in the CO₂ cartridge can be released by means of a pull cord 44, which preferably has a bright colour so that it can be quickly found in emergency situations. Pulling the pull cord 44 from the inoperative condition shown in FIGS. 6 and 7 will result in the gas in the CO₂ cartridge being released and the gas chamber 43 being filled with gas, so that it is inflated. The walls of the gas chamber 43 are so configured that the gas chamber 43 is curved, at least in vertical cross-section as shown in FIG. 8, with the gas chamber 43 extending upwards along the mattress 32 from the underside thereof in the direction of a person 45 lying on the mattress 32. Alternatively, a gas chamber may be connected to the central portion 35 by means of a restriction element, for example a belt, in such a manner that the restriction element prevents the gas chamber from swinging (too) far outwards. In this way the gas chamber will maintain a slightly upward orientation beside the bed, so that the wrapping sheet connected thereto will remain within easy reach.

The wrapping portion 42 likewise comprises a gas chamber 46 with a pull cord 47 for controlling a CO₂ cartridge associated with the gas chamber 46. In inflated condition the gas chamber 46 is, in this example, mirror symmetrical with respect to the gas chamber 43. The wrapping portion 42 further comprises a coated wrapping sheet 47 which, just like the gas chambers 43, 46, extends at least substantially along a length l. On one long side the coated sheet of 47 is fixed to the upper side of the gas chamber 46. On the opposite long side, the coated sheet 47 is provided with Velcro material which can mate with Velcro material 49 on the upper side of the gas chamber 43. The Velcro material 48, 49 preferably extends at least over a considerable part of the length l, so that the coated wrapping sheet 47 and the gas chamber 43 can be securely fastened together. Thus a patient 45, or at least said patient's trunk, can be enveloped in the mattress 32, the gas chamber 46, the wrapping sheet 47 and the gas chamber 43, with the bottom sides of the wrapping portions 11 and 12 being connected via the central portion 35 of the sheet 33. The coated wrapping sheet 47 is preferably provided with handles, for example cut-out, edged handles, at the location of the Velcro material 48 to facilitate fastening the Velcro material 48 to the Velcro material 49.

In the event of an emergency, when it is necessary to evacuate a person 45 lying on a mattress 32, attendant staff will be able to remove the wrapping portions 41, 42 from under the mattress 32 very quickly by pulling the pull cords 44, 47, causing the gas chambers 43, 46 to be inflated. It is noted in that connection that one of the two pull cords 44, 47 may be longer than the other pull cord, so that the ends of the pull cords 44, 47 can be located on the same long side of the bed 34. In the present preferred embodiment it would be preferable in that case if the pull cord 47 is lengthened so as to be available beside the pull cord 44. After the gas chambers 43, 46 have been inflated, an attendant standing beside the bed on the long side thereof will grasp the wrapping sheet 47 and then press the Velcro material 48 thereof onto the Velcro material 49 of the gas chamber 43. In this way the person 45 is fully wrapped and the actual evacuation can begin by dragging the evacuation device 31 together with the mattress 32 and the person 45 off the bed 34 by means of one or both drag loops 49 and then to an (emergency) exit of the building in question. Thus, not only the mattress 32 but also the gas chambers 43, 46 confer a certain degree of protection to the person 45 during the evacuation.

A major advantage of the evacuation device 31 is the minimum amount of time required for preparing the evacuation of the person 45.

The above description, which refers to preferred embodiments illustrated in the figures, does not in any way limit the scope of the present invention, which is defined in the appended claims. The curvature of the gas chambers, which extend obliquely upwards because of said curvature when the wrapping portions are filled, may for example be realised only by the configuration of the wrapping portions, or only by means of a belt.

1. A device for evacuating a person lying on a mattress, comprising a central portion having two opposite long sides and two opposite short sides, which sides substantially correspond to those of a mattress with which the device is used, said device comprising wrapping means for wrapping the mattress and a person lying thereon, said wrapping means comprising an at least partially flexible wrapping element having two projecting parts which each extend from underneath a respective long side of the mattress in the wrapping position, and fastening means for fastening the two projecting parts together when forming the envelope, characterised in that said at least one flexible wrapping element of the device according to the invention comprises a first wrapping sheet on a first long side of the central portion.

2. A device according to claim 1, characterised in that the at least partially flexible wrapping element comprises a second wrapping sheet on the long side of the central portion that is located opposite said first long side of the central portion.

3. A device according to claim 1 characterised in that the wrapping means comprise a third wrapping sheet on a short side of the central portion.

4. A device according to any one or more of the preceding claims, characterised in that the first, the second and/or the third wrapping sheet comprise(s) a fire retardant material.

5. A device according to claim 1, characterised in that the device comprises at least one self-inflatable gas chamber, which is connected to said at least one wrapping sheet for moving the at least one wrapping sheet from under the mattress on at least one long side of the mattress upon inflation of the gas chamber, and control means for triggering the self-inflation of the gas chamber.

6. A device according to claim 5, characterised in that the device comprises two self-inflatable gas chambers connected to the respective projecting parts of the wrapping element for moving the projecting parts of the wrapping element from under the mattress on the respective long sides of the mattress upon inflation of the gas chambers.

7. A device according to claim 5 characterised in that the gas chamber independently extends at least partially upwards along the respective long side of the mattress in the inflated condition.

8. A device according to claim 5, characterised in that the gas chamber independently takes on a curved shape in inflated condition so as to envelope the person to be evacuated at least partially.

9. A device according to claim 5, characterised in that said at least one gas chamber comprises a gas cartridge.

10. A device according to claim 5, characterised in that at least part of the wall of the gas chamber forms part of the associated projecting part.

11. A device according to claim 5, characterised in that the control means comprise a pull cord.

12. A device according to claim 1, characterised in that said fastening means comprise Velcro.

13. A device according to claim 1, characterised in that the first, the second and/or the third wrapping sheet is (are) provided with at least one handle.

14. A device according to claim 1, characterised in that the device is provided with positioning means for positioning at least a part of the wrapping means under a mattress.

15. A device according to claim 14, characterised in that the positioning means are suitable for maintaining the wrapping sheet in question in a desired position under a mattress.

16. A device according to claim 15, characterised in that the positioning means are suitable for maintaining the wrapping sheet in question under a mattress in a position in which it is folded about a fold line extending substantially parallel to the adjacent side of the central portion.

17. A device according to claim 14, characterised in that the positioning means comprise Velcro.

18. A device according to claim 14, characterised in that he positioning means are at least in part provided on one or more wrapping elements.

19. A device according to claim 1, characterised in that the device is provided with a dragging element on at least one short side.

20. A method for evacuating a person lying on a mattress, characterised in that the mattress, including the person lying thereon, is wrapped by means of a device according to claim 1.
